(19) United States
(12) Patent Application Publication
(10) Pub. No.: US 2002/0065035 A1
(43) Pub. Date: May 30, 2002

(54) Method of and system for contents distribution

(76) Inventor: Masayuki Koshino, Tokyo (JP)

Correspondence Address: BIRCH STEWART KOLASCH & BIRCH, PO BOX 747, FALLS CHURCH, VA, 22040-0747, US

(21) Appl. No.: 09/887,327

(22) Filed: Jun. 25, 2001

(30) Foreign Application Priority Data
Nov. 28, 2000 (JP) 2000-361793

(51) Int. Cl. H04H 1/00

(52) U.S. Cl. 455/3.01

(57) ABSTRACT

The contents distribution station includes channel allocation unit which judges whether the number of contents reception stations receiving a certain contents is large or small. When the number is large, a broadcast channel is allocated to a reception station newly making a request for distribution of contents. When the number is small, an occupied channel is allocated to the reception station newly making a request for distribution of contents.

### FIELD OF THE INVENTION

The present invention relates to a technology for contents distribution, by which wireless communication channels used for contents distribution are efficiently allocated.

### BACKGROUND OF THE INVENTION

Conventionally, contents such as music, pictures, broadcasting programs, traffic information, weather information, stock price information, other data changing in real time, and so on were distributed to terminals (reception stations) of each user by wireless transmission. The following methods were used for distribution. That is, a simultaneous distribution method of distributing the contents to the general public using shared channels; and a distribution method of distributing the contents only to specified reception stations using occupied channels.

In the simultaneous distribution method, the shared channels are previously determined for each of contents at a side of a contents distribution station. The reception stations acquire desired contents by selection of some known shared channels.

On the other hand, in the distribution method by which

On the other hand, in the distribution method by which the distribution is performed only to specified reception stations, a contents distribution station allocates an occupied channel to a reception station, when receiving a distribution request of certain contents from the above reception station. The reception station acquires desired contents through the allocated channel. Especially, the allocated channel is not changed after the allocation until the contents distribution is completed.

However, there has been a problem in the conventional contents distribution method using shared channels that the number of contents which can be simultaneously received and selected by a user decreases if the number of channels that can be shared is less. On the other hand, there has been another problem that channels allocated to contents with less opportunity to be selected by users are uselessly wasted in the case of increased number of shared channels.

Moreover, there has been a problem in the conventional contents distribution method using occupied channels that, as an equal number of channels to that of reception stations are required even when the same contents is received by different users, channels are uselessly wasted as a necessary consequence.

A method of previously determination which channel of the shared or occupied channels is to used for each contents in combined use of the shared channels and the occupied channels is also known. However, it is difficult in actual case to previously determine suitable allocation, as a number of distribution requests by users for a certain contents largely changes depending on situations.

### SUMMARY OF THE INVENTION

It is an object of this invention to obtain a method of and system for contents distribution, by which wireless communication channels used for contents distribution are efficiently allocated. It is another object of this invention to provide a computer readable recording medium that stores a computer program which when executed realizes the method according to the present invention.

In the method and system according to the present invention, contents are distributed from a contents distribution station to contents reception stations using wireless communication channels. The contents distribution stations receive distribution request of contents from the contents reception stations. The contents distribution station acquires the total number of other contents reception stations receiving the same contents as the above contents to be distributed. Finally, the contents distribution station allocates a broadcast channel for simultaneous distribution to all the contents reception stations, or occupied channels individually set respectively to contents reception stations, as channels used for distribution of the above contents to contents reception stations performing distribution request for the above contents, based on the total number of other contents reception stations.

The computer readable recording medium according to another aspect of the present invention stores a computer program which when executed realizes the method according to the present invention.

Other objects and features of this invention will become apparent from the following description with reference to the accompanying drawings.

### BRIEF DESCRIPTION OF THE DRAWINGS

FIG. 1 is a block diagram showing a schematic configuration of a contents distribution system according to an embodiment;

FIG. 2A to FIG. 2E are views showing what is stored in the tables in a memory of a contents distribution system according to an embodiment;

FIG. 3 is a flow chart showing the operations for channel switching and allocation of a contents distribution station in an contents distribution system according to an embodiment;

FIG. 4 is a flow chart showing processing for determination of an occupied channel allocation in a contents distribution system according to an embodiment;

FIG. 5 is a flow chart showing processing for determination of a broadcast channel allocation in a contents distribution system according to an embodiment;

FIG. 6 is a flow chart showing processing for determination of occupied channel switching and allocation in a contents distribution system according to an embodiment;

FIG. 7 is a flow chart showing processing for determination of broadcast channel switching and allocation in a contents distribution system according to an embodiment;

FIG. 8 is a flow chart showing processing at a transmission message processing unit in a contents distribution system according to an embodiment;

FIG. 9 is a flow chart showing operations for channel switching and setting of a contents reception station in a contents distribution system according to an embodiment; and

FIG. 10 is a flowchart showing operations for contents distribution of a contents reception station in a contents distribution system according to an embodiment.

### DESCRIPTION OF THE PREFERRED EMBODIMENTS

Preferred embodiments of the system of and method for contents distribution according to the present invention will be described in detail while referring to the accompanying drawings. However, the present invention is not limited to these embodiments.

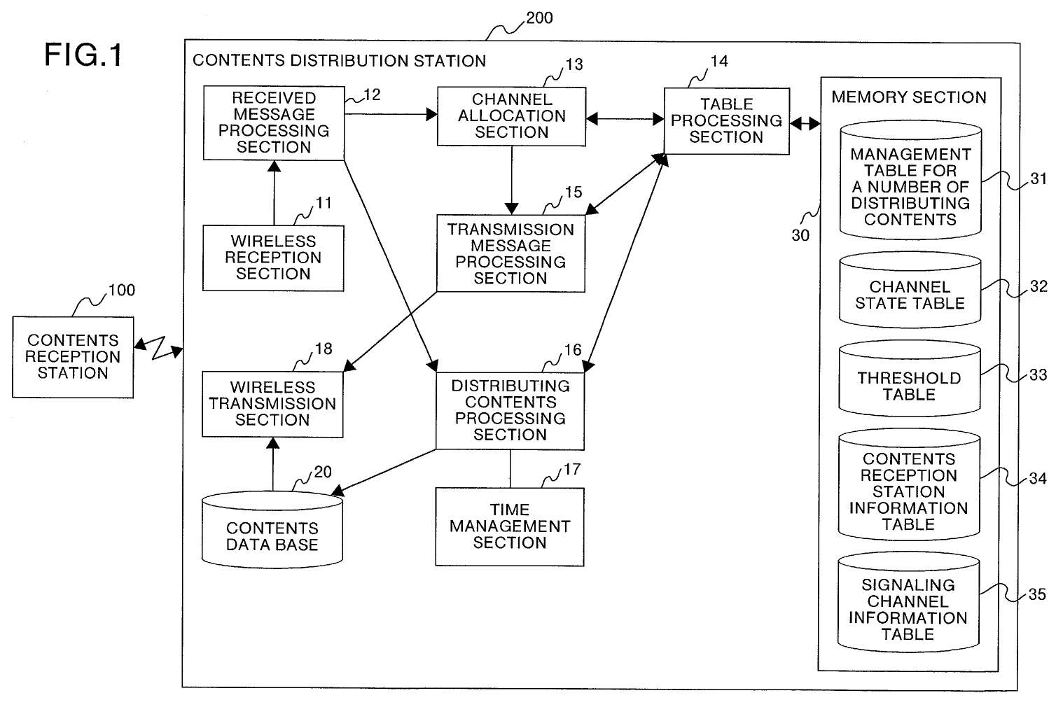

FIG. 1 is a block diagram showing a schematic configuration of the system for contents distribution according to an embodiment. This system includes contents reception station 100 and contents distribution station 200. The reception station 100 and the contents distribution station 200 communicate with each other through wireless channels. Relay stations and so on are required for wireless access. However, because known relay stations and so on may be used, their description will be omitted.

The contents distribution station 200 includes following components. Memory 30 for storage of a plurality of information tables. Wireless reception unit 11 for processing of wireless reception data. Reception message processing unit 12 for processing of reception data received from the wireless reception unit 11. Channel allocation unit 13 for allocation and release of wireless channels for contents distribution according to requests from the reception message processing unit 12. Wireless transmission unit 18 for transmission of wireless transmission data. Transmission message processing unit 15 for generation of transmission messages and wireless channel assignment to the wireless transmission unit 18. Table processing unit 14 for writing into and reading from information tables in the memory 30. Distributing contents processing unit 16 for control of contents distribution. Time management unit 17 for monitoring whether it is a time assigned by the distributing contents processing unit 16, and for notification when it reaches the above time. Finally, contents data base 20 for storage of distributing contents data.

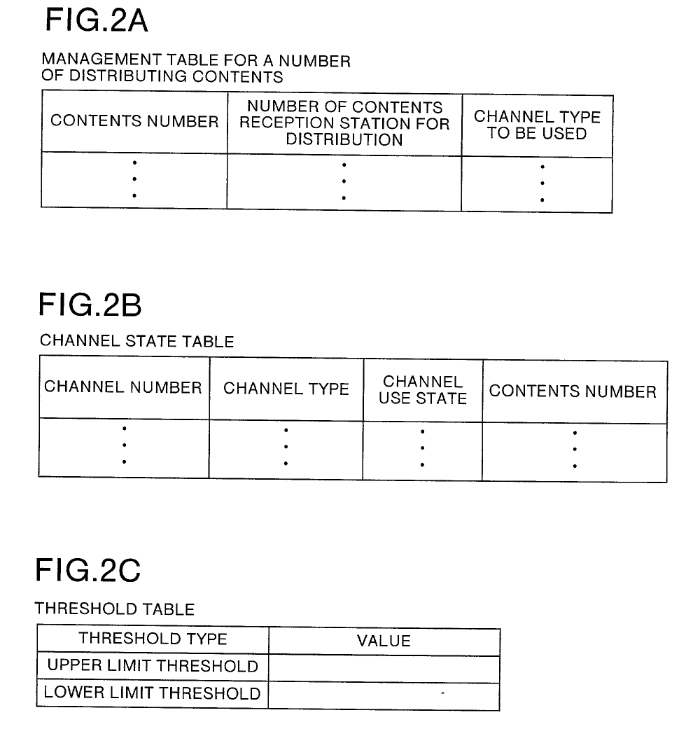

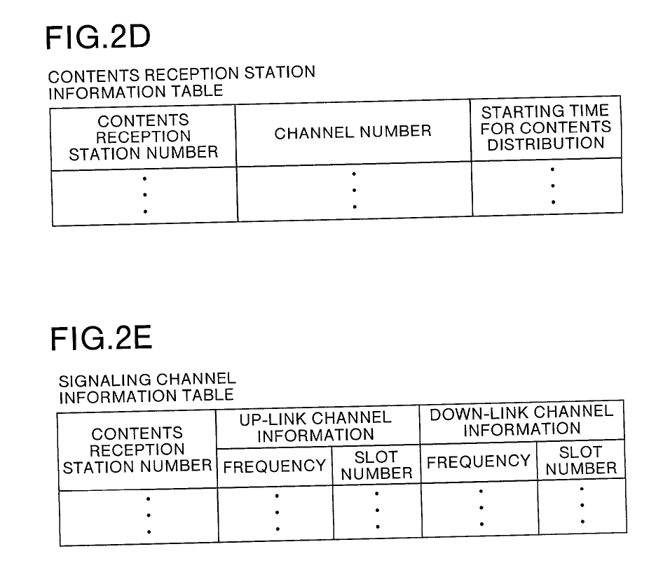

Moreover, the memory 30 includes management table for a number of distributing contents 31, channel state table 32, threshold table 33, contents reception station information table 34, and signaling channel information table 35. FIG. 2A to FIG. 2E are views showing what is stored in the tables in the memory 30.

The management table for a number of distributing contents 31 is a table for management of number of contents reception stations currently receiving each contents. This table 31 stores, as shown in FIG. 2A, contents numbers, numbers of contents reception stations receiving the contents, and channel types to be used. The contents number denotes an identification number of the contents for distribution; the number of contents reception stations receiving the contents shows a number of contents reception stations to which the corresponding contents is currently being distributed as a destination; and channel types to be used are expressed as, for example, “0” for a wireless channel occupied by a contents reception station (hereinafter, called as an occupied channel), and as “1” for a wireless channel shared among contents reception stations (hereinafter, called as a broadcast channel).

The channel state table 32 is a table for management of the types, in use or not in use, and the corresponding contents number during use for each wireless channel. This table 32 stores, as shown in FIG. 2B, channel numbers, channel types, channel use states, and contents numbers. The channel number represents an identification number of a wireless channel; the channel type is expressed in a similar manner to that of the above channel types to be used; and the channel use state is expressed as, for example, “0” for a channel in a not-in-use state, as “1” for a reserved channel, and as “2” for a channel in an in-use state; and the contents number denotes an identification number of contents under transmission using the corresponding channel.

The threshold table 33 is a table for storage of information on thresholds to be used for channel allocation. This table 33 stores, as shown in FIG. 2C, upper limit thresholds and lower limit ones on numbers of contents reception stations receiving one piece of distributing contents.

The contents reception station information table 34 is a table for management of various kinds of information on contents reception stations undergoing the contents distribution. This table 34 stores, as shown in FIG. 2D, contents reception station numbers, channel numbers, and starting times of the contents distribution. The contents reception station number denotes an identification number of a contents reception station undergoing the contents distribution; the channel number represents an identification number of a wireless channel used for contents distribution to the corresponding contents reception station; and the starting time of the contents distribution denotes time when the contents distribution to the corresponding contents reception station is started.

The signaling channel information table 35 is a table for management of specified information on wireless channels used for communication with contents reception stations. This table 35 stores, as shown in FIG. 2E, contents reception station numbers, up link channel information (frequencies and slot numbers), and down link channel information (frequencies and slot numbers). The contents reception station number represents an identification number of a contents reception station; the up link channel information denotes the frequency and slot number of signaling channels in the direction from the corresponding contents reception station to the contents distribution station; and the down link channel information shows the frequency and slot number of signaling channels in the direction from the contents distribution station to the corresponding contents reception station.

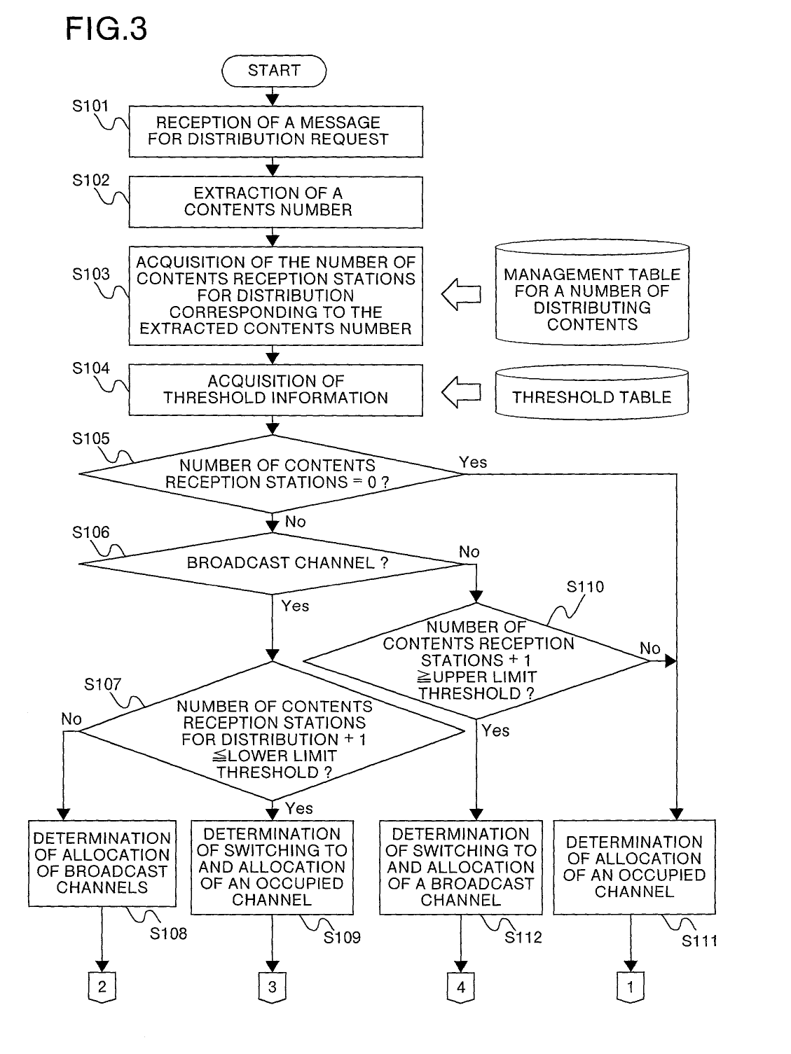

Operations of the above-mentioned system according to an embodiment of the present invention will be described now. In the first place, the operations for a case where the contents distribution station 200 receives a distribution request from the contents reception station 100 will be described. FIG. 3 is a flow chart showing the operations of the system for contents distribution, and, especially, shows channel switching and allocation operations at a contents distribution station.

First of all, in the contents distribution station 200, the wireless reception unit 11 fetches a reception message; and transmits the fetched reception message to the reception message processing unit 12 (step S101) , when the wireless reception unit 11 receives wireless reception data from the contents reception station 100. If the above reception message is a message for distribution request, the reception message processing unit 12 extracts a contents number undergoing the distribution request from the reception message, and transmits allocation request for a channel setting the above contents number to the channel allocation unit 13 (step S102).

The channel allocation unit 13 transmits request for information acquisition for assignment of acquisition of information on the extracted contents number and threshold information to the table processing unit 14. The table processing unit 14 receives the above request for information acquisition; reads information on the assigned contents number from the management table for a number of distributing contents 31 in the memory 30 and, simultaneously, the threshold information from the threshold table 33; and replies table data including the above read information to the channel allocation unit 13.

When the channel allocation unit 13 receives the above table data, the channel allocation unit 13 acquires the number of contents reception station receiving the corresponding contents to the assigned contents number, and channel types to be used for distribution (step S103) , and at the same time, the upper and lower limit thresholds (step S104).

When the acquired number of contents reception stations receiving the contents is 0 (Yes at step S105), an occupied channel of a contents reception station 100 transmitting a message for distribution request is determined to be allocated for contents distribution to the above contents reception station 100 without judgment of the channel types to be used for distribution (step S111) This determination is called as determination of occupied channel allocation.

On the other hand, when the acquired number of contents reception station receiving the contents is not 0 (No at step S105), and, the channel type for distribution is a broadcast channel (Yes at step S106), it is judged whether a number after addition of 1 to the number of contents reception stations receiving contents acquired at the above step S103 is equal to or less than the lower limit threshold acquired at the above step S104 (step S107).

When a number at step S107 after addition of 1 to the number of contents reception stations receiving contents is larger than that of the lower limit threshold, it is determined that a channel for distribution which a contents reception station with contents already distributed is using, that is, a broadcast channel is also allocated to a contents reception station 100 transmitting a message for distribution request (step S108). This determination is called as determination of broadcast channel allocation.

When a number at step S107 after addition of 1 to the number of contents reception stations receiving contents is equal to or less than the lower limit threshold, it is determined that a channel for distribution which the contents reception station with contents already distributed is using, that is, a broadcast channel is switched to an occupied channel of the above contents reception station, and another occupied channel of a contents reception station 100 transmitting a message for distribution request is also allocated to the above contents reception station 100 (step S109). This determination is called as determination of occupied channel switching and allocation.

Moreover, when the acquired number of contents reception station receiving the contents is not 0 (No at step S105), and, the channel type for distribution is not a broadcast channel, that is, an occupied channel of the contents reception station (No at step S106), it is judged whether a number after addition of 1 to the number, which is acquired at the above step S103, of contents reception stations receiving contents is equal to or larger than the upper limit threshold acquired at the above step S104 (step S110).

When a number at step S110 after addition of 1 to the number of contents reception stations receiving contents is equal to or larger than the upper limit threshold, it is determined that a channel for distribution which the contents reception station with contents already distributed is using, that is, an occupied channel of the above contents reception station is switched to a broadcast channel, and the above broadcast channel is also allocated to another contents reception station 100 transmitting a message for distribution request (step S112). This determination is called as determination of broadcast channel switching and allocation.

When a number at step S110 after addition of 1 to the number of contents reception stations receiving contents is less than the upper limit threshold, it is determined that an occupied channel of a contents reception station 100 transmitting a message for distribution request is allocated for contents distribution to the above contents reception station 100, in a similar manner to that of the above determination of occupied channel allocation (step S111).

Then, actual processing for switching and allocation, based on the above determination such as that of occupied channel allocation, broadcast allocation, occupied switching and allocation, and broadcast channel switching and allocation, will be described.

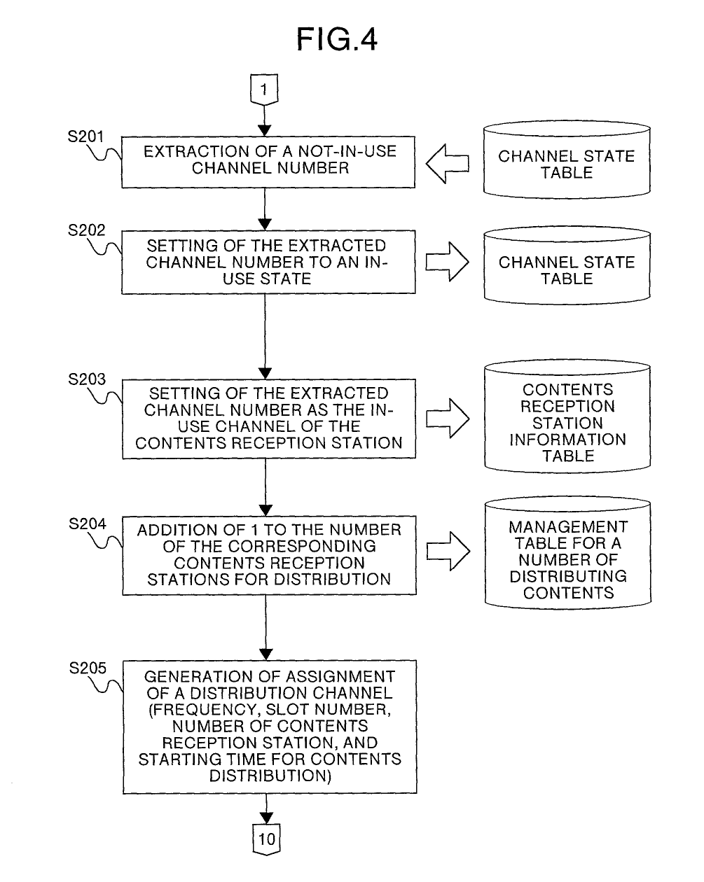

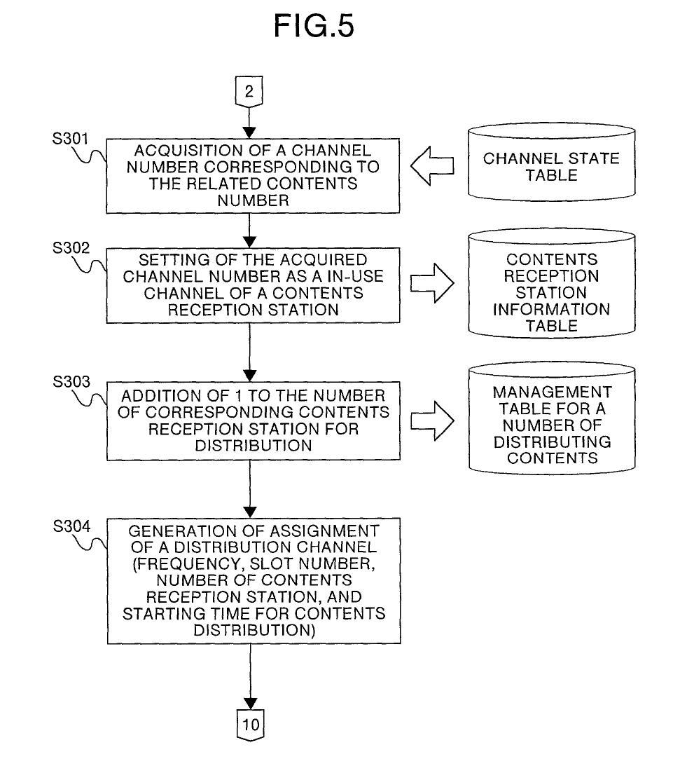

First of all, processing for determination of occupied channel allocation will be described. FIG. 4 is a flow chart showing the processing for determination of occupied channel allocation. In the above determination, the channel allocation unit 13 transmits request for information acquisition to acquire the use state of channels to the table processing unit 14. When the table processing unit 14 receives the above request for information acquisition, the table processing unit 14 replies table data including the content of the channel state table 32 on the memory 30 to the channel allocation unit 13.

Then, the channel allocation unit 13 extracts one of channels which are in a not-in-use state, referring to the use state of the channels from the above table data, and acquires the number of the above channel. At the same time, the frequency and the slot number are determined (step S201) Further, the channel allocation unit 13 sets a channel use state corresponding to the channel number of the extracted channel as an in-use state, and other kinds of information are set in the channel state table 32 through the table processing unit 14 (step S202).

Moreover, the channel allocation unit 13 sets the channel number extracted at step S201 in the contents reception station information table 34 through the table processing unit 14, as a channel number to be used by the contents reception station 100 transmitting a message for distribution request (step S203). Moreover, the channel allocation unit 13 adds 1 to the number of the contents reception stations receiving contents, corresponding to the contents number extracted at the above step S102, in the management table for a number of distributing contents 31 through the table processing unit 14 (step S204). The processing performed in steps S202 to S204 through the table processing unit 14 is realized, specifically, by that the channel allocation unit 13 transmits request for information updating to assign each processing to the table processing unit 14.

Thereafter, the channel allocation unit 13 generates assignment of distribution channel including information on the frequency and the slot number determined at step S201; the corresponding contents reception station number; and starting time for contents distribution, and transmits it to the transmission message processing unit 15 (step S205).

Now, processing for determination of broadcast channel allocation will be described. FIG. 5 is a flowchart showing processing for determination of the broadcast channel allocation. In the above determination, the channel allocation unit 13 transmits request for information acquisition to acquire the use state of channels to the table processing unit 14. When the table processing unit 14 receives the above request for information acquisition, the table processing unit 14 replies the table data including the content of the channel state table 32 on the memory 30 to the channel allocation unit 13.

Then, the channel allocation unit 13 acquires a channel number corresponding to the contents number extracted at the above step S102, referring to the use state of channels from the table data, and determines the frequency and the slot number (step S301) . Moreover, the channel allocation unit 13 sets the channel number extracted at step S301 as a channel number for the contents reception station 100 transmitting a message for distribution request in the contents reception station information table 34 through the table processing unit 14 (step S302).

In addition, the channel allocation unit 13 adds 1 to the number of the contents reception stations receiving contents, corresponding to the contents number extracted at the above step S102, in the management table for a number of distributing contents 31 through the table processing unit 14 (step S303). The processing performed in the steps S302 and S303 through the table processing unit 14 is realized, specifically, by that the channel allocation unit 13 transmits request for information updating to assign each processing to the table processing unit 14.

Thereafter, the channel allocation unit 13 generates assignment of distribution channel including information on the frequency and the slot number determined at step S301; the corresponding contents reception station number; and starting time for contents distribution, and transmits it to the transmission message processing unit 15 (step S304).

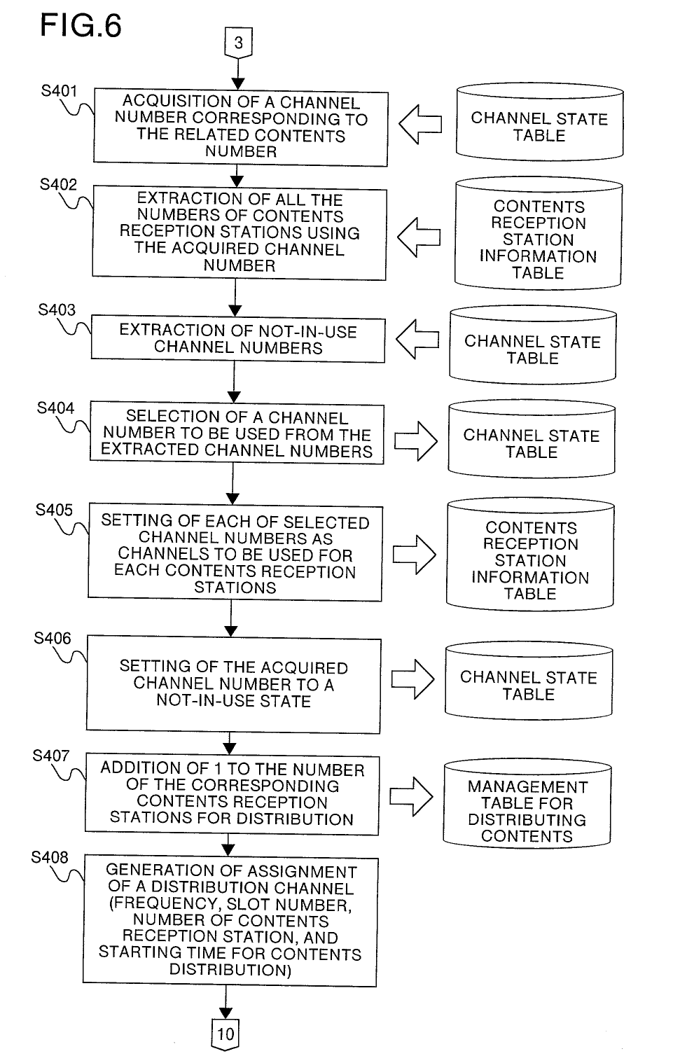

Now, processing for determination of occupied channel switching and allocation will be described. FIG. 6 is a flow chart showing processing for determination of occupied channel switching and allocation. In the above determination, the channel allocation unit 13 transmits request for information acquisition to acquire the use state of channels to the table processing unit 14. When the table processing unit 14 receives the above request for information acquisition, the table processing unit 14 replies the table data including the content of the channel state table 32 on the memory 30 to the channel allocation unit 13.

Then, the channel allocation unit 13 acquires a channel number corresponding to the contents number extracted at the above step S102, referring to the use state of the channel from the above table data (step S401). Subsequently, the channel allocation unit 13 transmits request for information acquisition to acquire information on the contents reception station to the table processing unit 14. When the table processing unit 14 receives the above request for information acquisition, the table processing unit 14 replies the table data including the content of the contents reception station information table 34 on the memory 30 to the channel allocation unit 13.

Then, the channel allocation unit 13 extracts all the contents reception station numbers using the channel numbers acquired at step S401 from the above table data (step S402).

Moreover, the channel allocation unit 13 transmits request for information acquisition to acquire the use state of channels to the table processing unit 14. When the table processing unit 14 receives the above request for information acquisition, the table processing unit 14 replies the table data including the content of the channel state table 32 on the memory 30 to the channel allocation unit 13.

Then, the channel allocation unit 13 extracts channels in a not-in-use state, referring to the use state of the channel from the above table data, and acquires the above channel numbers (step S403). In addition, the channel allocation unit 13 selects a channel number to be used among the channel numbers extracted at step S403 for determination of the frequency and the slot number, and the channel allocation unit 13 sets a channel use state corresponding to the selected channel number as an in-use state, and other kinds of information are set in the channel state table 32 through the table processing unit 14 (step S404).

Moreover, the channel allocation unit 13 allocates differently from each other and sets the channel numbers selected at step S404 as channel numbers used respectively for each contents reception station corresponding to the contents reception station numbers extracted at step S402 and the contents reception station 100 transmitting a message for distribution request in the contents reception station information table 34 through the table processing unit 14 (step S405).

Then, the channel allocation unit 13 sets the channel use states corresponding to all the channel numbers acquired at step S401 as a not-in-use state, and, at the same time, other kinds of information are also set in the channel state table 32 through the table processing unit 14 (step S406).

Moreover, the channel allocation unit 13 adds 1 to the number of the contents reception stations receiving contents, corresponding to the contents number extracted at the above step S102, in the management table for a number of distributing contents 31 through the table processing unit 14 (step S407). The processing performed in steps S404 to 407 through the table processing unit 14 is realized, specifically, by that the channel allocation unit 13 transmits request for information updating to assign each processing to the table processing unit 14.

Thereafter, the channel allocation unit 13 generates assignment of distribution channel including information on the frequency and the slot number determined for each channel number selected at step S404; each of the corresponding contents reception station numbers; and starting time for contents distribution; and assignment of channel switching, and transmits it to the transmission message processing unit 15 (step S408).

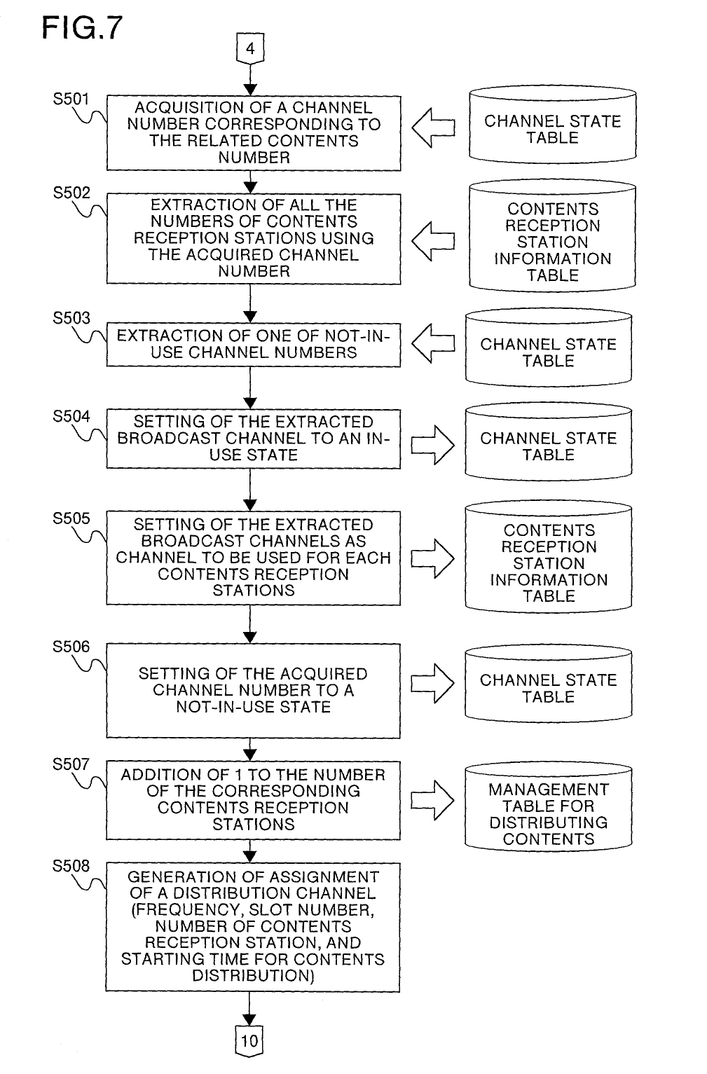

Now, processing for determination of broadcast channel switching and allocation will be described. FIG. 7 is a flow chart showing the processing for determination of broadcast channel switching and allocation. In the above determination, the channel allocation unit 13 transmits request for information acquisition to acquire the use state of channels to the table processing unit 14. When the table processing unit 14 receives the above request for information acquisition, the table processing unit 14 replies the table data including the content of the channel state table 32 on the memory 30 to the channel allocation unit 13.

Then, the channel allocation unit 13 acquires a channel number corresponding to the contents number extracted at the above step S102, referring to the use state of the channel from the above table data (step S501). Subsequently, the channel allocation unit 13 transmits request for information acquisition to acquire information on the contents reception station to the table processing unit 14. When the table processing unit 14 receives the above request for information acquisition, the table processing unit 14 replies the table data including the content of the contents reception station information table 34 on the memory 30 to the channel allocation unit 13.

Then, the channel allocation unit 13 extracts all the contents reception station numbers using the channel numbers acquired at step S501 from the above table data (step S502).

Moreover, the channel allocation unit 13 transmits request for information acquisition to acquire the use state of channels to the table processing unit 14. When the table processing unit 14 receives the above request for information acquisition, the table processing unit 14 replies the table data including the content of the channel state table 32 on the memory 30 to the channel allocation unit 13.

Then, the channel allocation unit 13 extracts one of broadcast channels which are in a not-in-use state, referring to the use state of the broadcast channels from the above table data, and acquires the above channel numbers. At the same time, the frequency and the slot number are determined (step S503). Moreover, the channel allocation unit 13 sets the channel use states corresponding to the channel numbers acquired at step S503 as an in-use state, and, at the same time, other kinds of information are also set in the channel state table 32 through the table processing unit 14 (step S504).

Moreover, the channel allocation unit 13 sets the channel numbers selected at step S503 as channel numbers used respectively for each contents reception station corresponding to the contents reception station numbers extracted at step S502 and the contents reception station 100 transmitting a message for distribution request in the contents reception station information table 34 through the table processing unit 14 (step S505).

Then, the channel allocation unit 13 sets the channel use states corresponding to all the channel numbers acquired at step S501 as a not-in-use state, and, at the same time, other kinds of information are also set in the channel state table 32 through the table processing unit 14 (step S506).

Moreover, the channel allocation unit 13 adds 1 to the number of the contents reception stations receiving contents, corresponding to the contents number extracted at the above step S102, in the management table for a number of distributing contents 31 through the table processing unit 14 (step S507). The processing performed in steps S504 to 507 through the table processing unit 14 is realized, specifically, by that the channel allocation unit 13 transmits request for information updating to assign each processing to the table processing unit 14.

Thereafter, the channel allocation unit 13 generates assignment of distribution channel including information on the frequency and the slot number determined for broadcast channel extracted at step S503; each of the corresponding contents reception station number; starting time for contents distribution; and assignment of channel switching, and transmits it to the transmission message processing unit 15 (step S508).

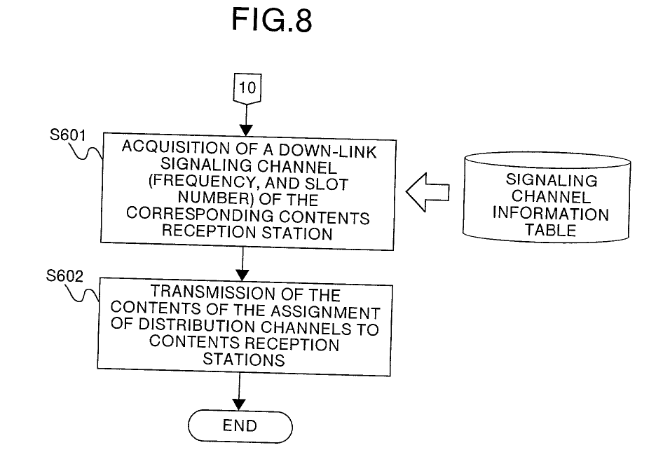

Now, processing at the transmission message processing unit 15 for transmission (step S205, S304, S408, and S508) of assignment of distribution channels at each of the above determination will be described. FIG. 8 is a flow chart showing processing at the transmission message processing unit.

When the transmission message processing unit 15 receives the above assignment of distribution channels from the channel allocation unit 13, the transmission message processing unit 15 transmits request for information acquisition to acquire signaling channel information to the table processing unit 14. When the table processing unit 14 receives the above request for information acquisition, the table processing unit 14 replies the table data including the content of the signaling channel information table 35 on the memory 30 to the transmission message processing unit 15.

Then, the transmission message processing unit 15 acquires down link channel information (frequency and slot number) corresponding to a contents reception station number set by the assignment of a distribution channel from the above table data (step S601). Thereafter, the transmission message processing unit 15 transmits request for transmission including the above assignment of a distribution channel and the down link channel information acquired at step S601 to the wireless transmission unit 18.

The wireless transmission unit 18 transmits the above assignment of a distribution channel to the contents reception station 100, using the channel assigned by the down link channel information (frequency, and slot number) included in the above request for transmission (step S602).

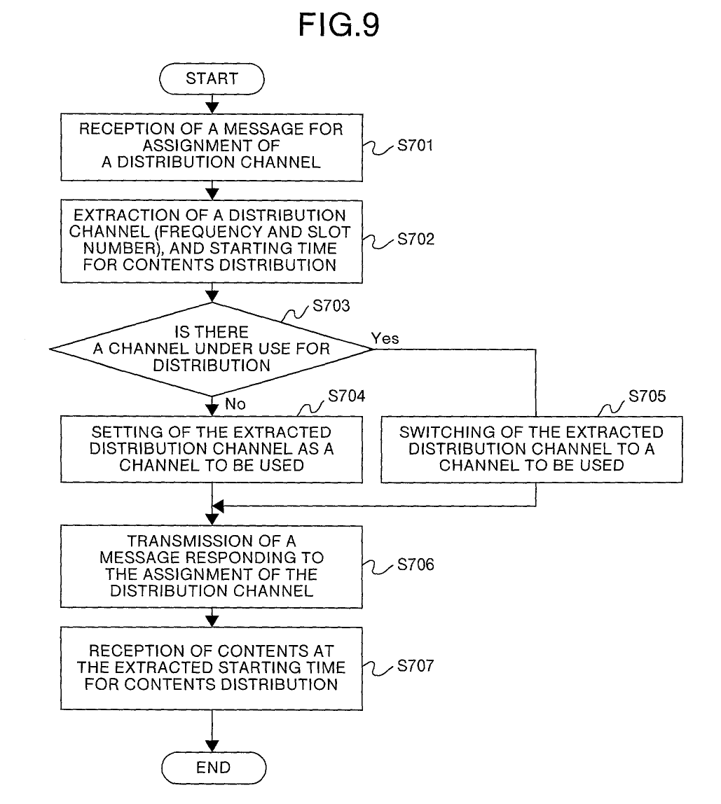

Now, the operations of the contents reception station 100 at reception of the assignment of distribution channels from the contents distribution station 200 will be described. FIG. 9 is a flow chart showing the operations of the contents distribution system, especially, the operations for channel switching and setting.

When the contents reception station 100 receives the assignment of distribution channels (step S701), the contents reception station 100 extracts the number of channel (frequency, and slot number) and the starting time for contents (step S702). If there has already been a channel in use for distribution in the contents reception station 100 (Yes at step S703), the channel is switched to the channel extracted at step S702 (step S705).

If there is no channel in use for distribution (No at step S703), the channel extracted at step S702 is set as a channel for distribution (step S704). Moreover, the contents reception station 100 transmits a response to the assignment of distribution channels including the identification number of the contents reception station 100 to the contents distribution station 200, using an up link signaling channel occupied each the contents reception station 100 (step S706).

Thereafter, the contents reception station 100 starts the reception of contents, using the channel extracted at step S702, at the distribution starting time extracted at step S702 (step S707).

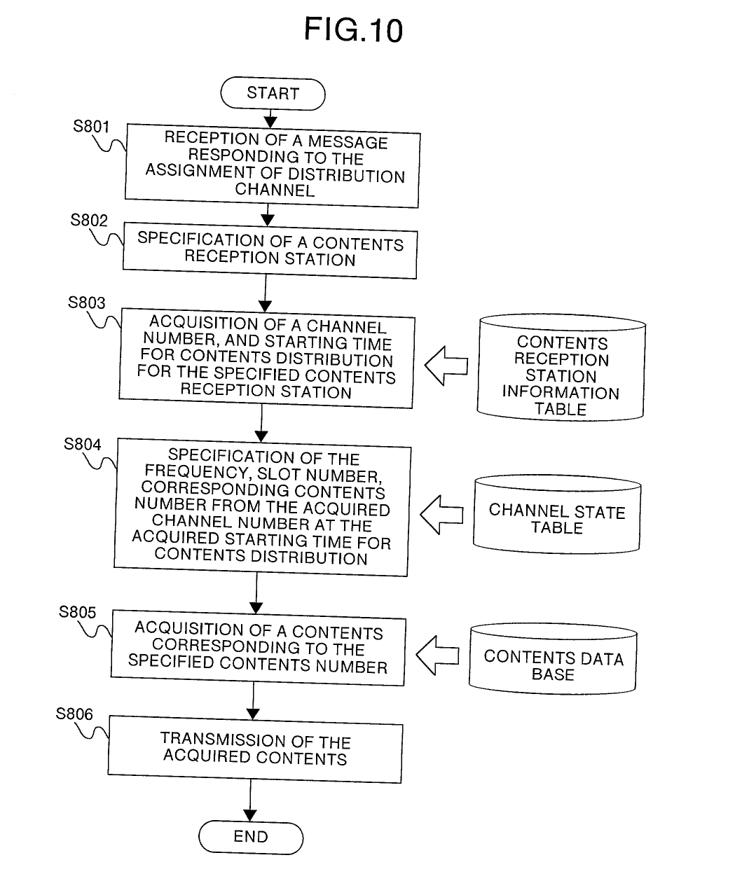

Now, the operations of the contents distribution station 200 at reception of the response to the assignment of distribution channels from the contents reception station 100 will be described. FIG. 10 is a flow chart showing the operations for contents distribution at the contents distribution station.

When the contents distribution station 200 receives wireless reception data from the contents reception station 100 in the wireless reception unit 11, the contents distribution station 200 fetches the reception message, and transmits the fetched reception message to the reception message processing unit 12 (step S801). If the above reception message is the response to the assignment of distribution channels, the reception message processing unit 12 transmits the above reception message to the distributing contents processing unit 16.

The distributing contents processing unit 16 specifies the contents reception station 100 from the received reception message (step S802); reads the contents reception station information table 34 through the table processing unit 14; and acquires the starting time for contents distribution for the specified contents reception station 100 (step S803) . Then, the distributing contents processing unit 16 transmits request for distributing timing including the number of the contents reception station 100, and the acquired starting time for contents distribution to the time management unit 17.

The time management unit 17 monitors whether it is a time assigned by the request for distributing timing, and transmits notification of distributing timing including the contents reception station number to the distributing contents processing unit 16, when it reaches the above time.

The distributing contents processing unit 16 reads the contents reception station information table 34 through the table processing unit 14, responding to the above notification of distributing timing, and acquires the channel number of the contents reception station assigned by the received notification of distributing timing (step S803). Thereafter, the distributing contents processing unit 16 reads the channel state table 32 through the table processing unit 14, and acquires the frequency, slot number, and contents number of the channel corresponding to the channel number acquired at step S803 (step S804).

Subsequently, the distributing contents processing unit 16 transmits request for transmission of contents data including the above frequency, slot number, and contents number of the channel to the contents data base 20. The contents data base 20 acquires the contents data corresponding to the assigned contents number, responding to the request for transmission of contents data (step S805), and generates transmission contents data added with the frequency and slot number of the above channel for transmission to the wireless transmission unit 18.

When the wireless transmission unit 18 receives the transmission contents data, the wireless transmission unit 18 transmits contents data included in the above transmission contents data as wireless transmission data, using the frequency and slot number of the assigned channel (step S806).

A computer program containing instructions which when executed on a computer causes the computer to perform the method according to the present invention is recorded on computer readable-recording medium. This computer readable-recording medium may be a floppy disk or a CD-ROM. Alternately the program may be stored at a server and the program may be downloaded when required. Otherwise, the program maybe executed while it is at the server, i.e. without downloading from the server.

As described above, according to the system and method for contents distribution according to this embodiment, a number of contents reception stations receiving the distributed contents, which is requested for distribution, is examined for contents undergoing distribution request. When this number is equal to or less than a predetermined lower limit threshold, the channel type used for the above contents distribution is set as a channel occupied for each contents reception station, and, when this number is equal to or larger than a predetermined upper limit threshold, the channel type used for the above contents distribution is set as a broadcast channel. Therefore, the least waste of wireless channels at channel use may be realized at distribution request for contents and during distribution, and it is possible to effectively use a limited resource of wireless channels.

As described above, the present invention has an advantage that channel change may be realized according to contents use state, and effective use of wireless communication channels may be achieved, as a broadcast channel or an occupied channel is set for wireless communication channels used for contents distribution between a contents distribution station and contents reception stations according to the total number of other contents reception stations receiving the same distributed contents as the object contents of request for distribution.

Furthermore, there is an advantage that occupation of broadcast channels or occupied channels may be avoided, when a number of contents reception stations receiving contents is increased or decreased during distribution to each contents reception station using the corresponding occupied channels, as a broadcast channel or an occupied channel is set for wireless communication channels used for contents distribution between a contents distribution station and contents reception stations, according to the total number of other contents reception stations receiving the same contents as the contents to be distributed.

Furthermore, there is an advantage that release of broadcast channels allocated to contents with less opportunity to be used may be realized, and effective use of a limited resource of wireless channels may be achieved, as an occupied channel is set for wireless communication channels used for contents distribution between a contents distribution station and contents reception stations, when the total number of other contents reception stations receiving the same contents as the contents to be distributed is equal to or less than a predetermined lower limit value.

Furthermore, there is an advantage that release of occupied channels allocated for each contents reception station to contents with much opportunity to be used may be realized, and effective use of a limited resource of wireless channels may be achieved, as a broadcast channel is set for wireless communication channels used for contents distribution between a contents distribution station and contents reception stations, when the total number of other contents reception stations receiving the same contents as the contents to be distributed is equal to or larger than a predetermined upper limit value.

Furthermore, there is an advantage that channel allocation change, reception timing, and so on may be notified to contents reception stations, and effective channel changes at the side of contents reception stations maybe realized, as a contents distribution station transmits information on distribution to contents reception stations, using individual wireless communication channels previously set for all the contents reception stations.

Furthermore, there is an advantage that channel allocation change, and contents reception at a predetermined reception timing after the channel allocation change may be realized, as contents reception stations receive notification of information on distribution from a contents distribution station, using individual wireless communication channels previously set for all the contents reception stations.

Furthermore, there is an advantage that channel change according to the use state of contents may be realized, and effective use of wireless communication channels may be achieved, as a broadcast channel or an occupied channel is set for wireless communication channels used for contents distribution between a contents distribution station and contents reception stations, according to the total number of other contents reception stations receiving the same distributed contents as the object contents of request for distribution.

Furthermore, there is an advantage that occupation of a broadcast channel or an occupied channel may be avoided, when a number of contents reception stations receiving contents is increased or decreased during distribution to each contents reception station using corresponding occupied channels, as a broadcast channel or an occupied channel is set for wireless communication channels used for contents distribution between a contents distribution station and contents reception stations, according to the total number of other contents reception stations receiving the same contents as the contents to be distributed.

Furthermore, there is an advantage that release of broadcast channels allocated to contents with less opportunity to be used may be realized, and effective use of a limited resource of wireless channels may be achieved, as an occupied channel is set for wireless communication channels used for contents distribution between a contents distribution station and contents reception stations, when the total number of other contents reception stations receiving the same contents as the contents to be distributed is equal to or less than a predetermined lower limit value.

Furthermore, there is an advantage that release of occupied channels allocated for each contents reception station to contents with much opportunity to be used may be realized, and effective use of a limited resource of wireless channels may be achieved, as a broadcast channel is set for wireless communication channels used for contents distribution between a contents distribution station and contents reception stations, when the total number of other contents reception stations receiving the same contents as the contents to be distributed is equal to or larger than a predetermined upper limit value.

Furthermore, there is an advantage that channel allocation change, reception timing, and so on may be notified to contents reception stations, and effective channel changes and so on at the side of contents reception stations may be realized, as a contents distribution station transmits information on distribution to contents reception stations, using individual wireless communication channels previously set for all the contents reception stations.

Furthermore, there is an advantage that channel allocation change, and contents reception at a predetermined reception timing after the channel allocation change may be realized, as contents reception stations receive notification of information on distribution from a contents distribution station, using individual wireless communication channels previously set for all the contents reception stations.

Since a computer program which when executed realizes the method according to the present invention is stored in the computer-readable recording medium according to another aspect of the present invention, the method according to the present invention can be executed readily and automatically.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A system for contents distribution comprising:
a distribution station which distributes contents to a plurality of reception stations through wireless communication channels, wherein
said distribution station allocates, in response to distribution request for the contents from said reception stations, a broadcast channel for simultaneous distribution to all the contents reception stations, or an occupied channel individually set for each reception station as channels used for distribution of the contents to said reception station performing distribution request for the contents, according to the total number of other contents reception stations receiving the distribution of the contents.

2. The system for contents distribution according to claim 1, wherein said distribution station allocates a broadcast channel for simultaneous distribution to all the reception stations, or an occupied channel individually set for each reception station to each of said reception stations as channel used for distribution of the contents according to the total number of reception stations receiving the distribution of the same contents.

3. The system for contents distribution according to claim 2, wherein said distribution station allocates individual occupied channels respectively to reception stations performing distribution request for the contents, and to said other contents receiving stations, as channels used for contents distribution, when the total number of other reception stations receiving the distribution of the same contents as the contents to be distributed is equal to or less than a predetermined lower limit value.

4. The system for contents distribution according to claim 2, wherein, when the total number of other reception stations receiving the distribution of the same contents as the contents to be distributed is equal to or larger than a predetermined upper limit value, said distribution station allocates the same broadcast channel to reception stations performing distribution request for the contents, and to said other contents receiving stations as channels used for contents distribution.

5. The system for contents distribution according to claim 1, wherein said distribution station previously sets individual wireless communication channels respectively to all the reception stations, and notifies information on distribution such as said allocated channels, starting times for contents distribution, contents numbers for distribution, and so on to reception stations receiving the distribution of the contents, using said wireless communication channels.

6. The system for contents distribution according to claim 5, wherein said reception stations receive notification of said information on distribution, and set said allocated channels as channels receiving the distribution of the contents corresponding to the contents numbers; and receive the contents using said set channels when it reaches the starting time for the contents distribution.

7. A method of distributing contents from a distribution station to a plurality of reception stations through wireless communication channels, the method comprising the steps of:
said distribution stations receiving a request for distribution of contents from said reception stations;
said distribution station acquiring a total number of reception stations, other the reception station that had made the request, receiving the distribution of the same contents; and
said distribution station allocating a broadcast channel through which it is possible to simultaneously distributed the contents to all the reception stations, or a channel provided individually for each reception stations, as a channel used for distribution of the contents to said reception station that had made the request, based on acquired total number of other reception stations.

8. The method for contents distribution according to claim 7 further comprising a second channel allocation step where said distribution station allocates a broadcast channel for simultaneous distribution to all the reception stations, or occupied channels individually set respectively to reception stations included in said total number of the reception stations, according to said total number.

9. The method for contents distribution according to claim 8, wherein the two channel allocation steps allocate individual occupied channels respectively to reception stations performing distribution request of the contents, and to other reception stations receiving the distribution of the same contents as the contents to be distributed, when said total number of the reception stations is equal to or less than a predetermined lower limit value.

10. The method for contents distribution according to claim 8, wherein the two channel allocation steps allocate the same broadcast channels to the reception stations performing distribution request of the contents, and to other reception stations receiving the same contents as the contents to be distributed, when said total number of the reception stations is equal to or larger than a predetermined upper limit value.

11. The method for contents distribution according to claim 7 further comprising a distribution information notification step where said distribution station notifies information on distribution such as the allocated channels, starting times for contents distribution, contents numbers for distribution, and so on to reception stations receiving the contents distribution, using individual wireless communication channels previously set for all the reception stations.

12. The method for contents distribution according to claim 11 , further comprising the steps of,
said reception stations receiving notification of said information on distribution;
said reception stations setting the allocated channels as channels receiving the distribution of the contents corresponding to the contents numbers; and
said reception stations receiving the contents, using the set channels, when it reaches the starting time for the contents distribution.

13. A system for contents distribution comprising:
a plurality of reception stations which receive contents; and
a distribution station which distributes contents to the reception stations, through wireless communication channels, in response to a request for distribution of the contents from said reception stations, said distribution station including,
a request receiving unit which receives the request from a reception station;
a number of reception stations acquiring unit which acquires a total number of reception stations that are currently receiving the contents when said request receiving unit receives the request from said reception station; and
a channel allocation unit which allocates a broadcast channel to said reception station that had made the request based on the total number of reception stations that are currently receiving the contents, wherein said channel allocation unit may allocate a broadcast channel through which contents can be distributed simultaneously to all the reception stations, or may allocate a channel which is provided only for said reception station that had made the request.
